(19) United States
(12) Patent Application Publication
(10) Pub. No.: US 2014/0300998 A1
(43) Pub. Date: Oct. 9, 2014

(54) POWER MEASUREMENT AND PROTECTION APPARATUS

(71) Applicant: HON HAI PRECISION INDUSTRY CO., LTD., New Taipei (TW)

(72) Inventor: MENG-CHE YU, New Taipei (TW)

(73) Assignee: HON HAI PRECISION INDUSTRY CO., LTD., New Taipei (TW)

(21) Appl. No.: 14/230,110

(22) Filed: Mar. 31, 2014

(30) Foreign Application Priority Data
Apr. 8, 2013 (TW) 102112420

(51) Int. Cl. H02H 7/22

(52) U.S. Cl. CPC H02H 7/22
USPC 361/18

(57) ABSTRACT

A power measurement and protection apparatus includes a first connector, a second connector, a setting element, a power setting unit, a power measurement unit, a control unit, and a switch. The first connector is electrically connected to an electronic device. The second connector is electrically connected to a power supply. The power setting unit sets a reference power according to signals input by the setting element, and outputs the reference power to the control unit. The electronic device is powered by the power supply through the second connector, the switch, and the first connector in that order. The power measurement unit measures an actual power of the electronic device, and outputs the actual power to the control unit. The control unit turns off the switch to stop the electronic device from being powered by the power supply, when the actual power is greater than the reference power.

### FIELD

The present disclosure relates to a power measurement and protection apparatus.

### BACKGROUND

Electronic devices, such as computers and servers, are electrically connected to a power supply via connectors. However, if the electronic device is not functioning properly and the power supply maintains supplying power to the electronic device, the electronic device may be damaged. Therefore, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the presented embodiments.

FIG. 1 is an isometric view of an embodiment of a power measurement and protection apparatus.

FIG. 2 is a block diagram of the power measurement and protection apparatus of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references can mean “at least one.”

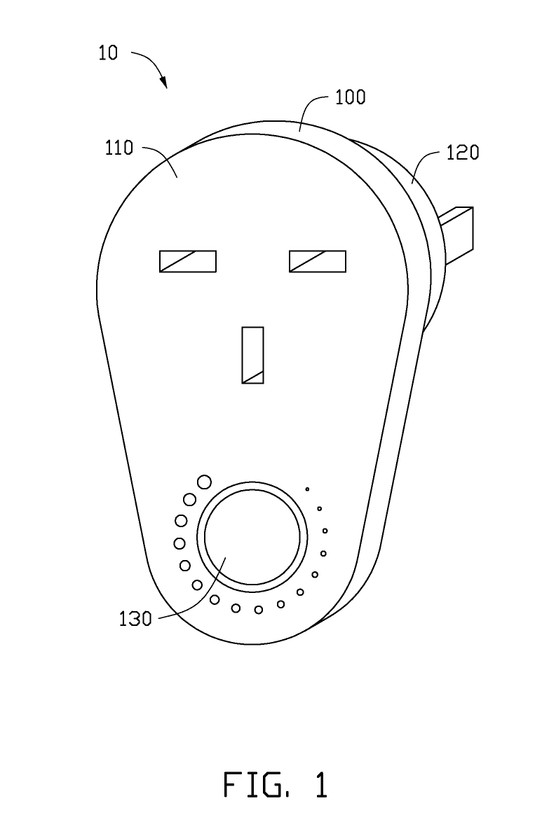

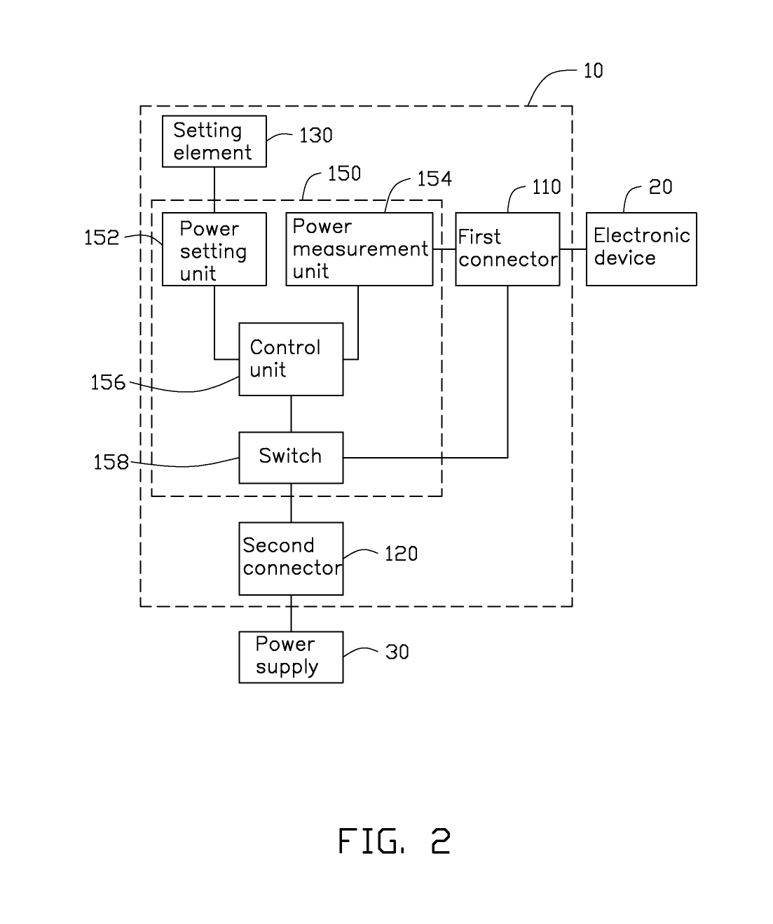

FIGS. 1 and 2 show an embodiment of a power measurement and protection apparatus 10. The power measurement and protection apparatus 10 can be electrically connected between an electronic device 20 and a power supply 30. The electronic device 20 can be powered by the power supply 30 through the power measurement and protection apparatus 10. The power measurement and protection apparatus 10 can be used for measuring an actual power of the electronic device 20, and determining whether the electronic device 20 is not functioning properly according to the actual power. The power measurement and protection apparatus 10 can be further used for stopping the electronic device 20 from being powered by the power supply 30 to protect the electronic device 20, when the electronic device 20 is not functioning properly

The power measurement and protection apparatus 10 comprises a main body 100 and a control circuit 150 received in the main body 100. The main body 100 comprises a first connector 110, a second connector 120, and a setting element 130. The control circuit 150 comprises a power setting unit 152, a power measurement unit 154, a control unit 156, and a switch 158. The power setting unit 152 can be electrically connected to the setting element 130 and the control unit 156. The power measurement unit 154 can be electrically connected to the first connector 110 and the control unit 156. The switch 158 can be electrically connected to the control unit 156, a first connector 110, and the second connector 120.

The first connector 110 can be used for electrically connecting to the electronic device 20. The second connector 120 can be used for electrically connecting to the power supply 30. The electronic device 20 can be powered by the power supply 30 via the second connector 120, the switch 158, and the first connector 110 in that order. The power setting unit 152 can be used for presetting a reference power according to signals input by the setting element 130, and outputting the reference power to the control unit 156. The power measurement unit 154 can be used for measuring the actual power of the electronic device 20 through the first connector 110, and outputting the actual power to the control unit 156. The control unit 156 can be used for determining whether the actual power is greater than the reference power, and turning off the switch 158 to stop the electronic device 20 from being powered by the power supply 30 when the actual power is greater than the reference power.

In at least one embodiment, the electronic device 20 may be a computer, a server, a refrigerator, or an air-conditioner. In at least one embodiment, the first connector 110 can be a female connector, the second connector 120 can be a male connector, the power measurement unit 154 can be a wattmeter, the switch 158 can be a relay, and the reference power can be a rated power of the electronic device 20.

In use, the setting element 130 can be operated to output the signals to the power setting unit 152 to preset the reference power. The first connector 110 is electrically connected to the electronic device 20, and the second connector 120 is electrically connected to the power supply 30. The electronic device 20 is powered by the power supply 30 through the second connector 120, the switch 158, and the first connector 110 in that order, and the electronic device 20 begins to operate. The power measurement unit 154 measures the actual power of the electronic device 20. When the actual power is greater than the reference power, which indicates the electronic device 20 is not functioning properly, the switch 158 is turned off by the control unit 156. When the switch 158 is turned off, the electronic device 20 is not powered by the power supply 30, and therefore is protected by the power measurement and protection apparatus 10.

As detailed above, the power measurement and protection apparatus 10 can stop the power supply 30 from supplying power to the electronic device 20 to protect the electronic device 20 from being damaged, when the actual power is greater than the reference power.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power measurement and protection apparatus comprising:
a main body comprising a first connector electrically connected to an electronic device, a second connector electrically connected to a power supply, and a setting element; and
a control circuit received in the main body and comprising:
a control unit;
a power setting unit electrically connected to the setting element to preset a reference power according to signals input by the setting element, and electrically connected to the control unit to output the reference power to the control unit;
a power measurement unit electrically connected to the first connector to measure an actual power of the electronic device through the first connector, and electrically connected to the control unit to output the actual power the control unit; and
a switch electrically connected to the first connector, the second connector, and the control unit;
wherein the electronic device is powered by the power supply through the second connector, the switch, and the first connector in that order; and
wherein the control unit determines whether the actual power being greater than the reference power, and turns off the switch to stop the electronic device being powered by the power supply, in response to the actual power being greater than the reference power.

2. The power measurement and protection apparatus of claim 1, wherein the power measurement unit is a wattmeter.

3. The power measurement and protection apparatus of claim 1, wherein the switch is a relay.

4. The power measurement and protection apparatus of claim 1, wherein the first connector is a female connector and the second connector is a male connector.
